(19) United States
(12) Patent Application Publication
(10) Pub. No.: US 2007/0030349 A1
(43) Pub. Date: Feb. 8, 2007

(54) Under vehicle inspection system

(76) Inventor: Larry E. Riley, Fritz Creek, AK (US)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/389,182

(22) Filed: Mar. 27, 2006

Related U.S. Application Data
(63) Continuation-in-part of application No. 11/045,074, filed on Jan. 31, 2005.

(51) Int. Cl. H04N 7/18

(52) U.S. Cl. 348/143

(57) ABSTRACT

An under vehicle inspection system is disclosed. The under vehicle inspection system comprises a vehicle undercarriage inspection platform, a sensor mounted on sensor carriage, and a data analysis element receiving and evaluating data obtained by the sensor.

### CROSS REFERENCE TO RELATED APPLICATIONS

This application is a continuation-in-part of U.S. patent application Ser. No. 11/045,074 filed on Jan. 31, 2005, the disclosure of which is hereby incorporated by reference in its entirety.

### STATEMENT OF GOVERNMENT SPONSORED RESEARCH

One or more agencies of the United States Government have a paid-up license in this invention and may in limited circumstances possess the right to require the patent owner to license others on reasonable terms as provided by the terms of Government Contract Number N00164-04-C-6653 awarded by the Naval Surface Warfare Center, Crane Ind.

### BACKGROUND OF THE INVENTION

1. Field of the Invention

Embodiments of the invention relate generally to an under vehicle inspection system. More particularly, embodiments of the invention relate to an under vehicle inspection system and related method of vehicle inspection.

2. Description of the Related Art

Criminals and terrorists have been known to transport drugs, explosives, stolen goods, and other forms of contraband in the undercarriages of vehicles. The term “undercarriage” here refers to all or part of the underside of a vehicle, including various nooks and crannies such as the wheel wells and areas between engine parts. The term “vehicle” specifically includes at least automobiles, vans, small trucks, construction equipment, and large trucks, such as so-called 18-wheelers as well as associated trailers and other towed assemblies.

Inspection stations have traditionally been set up in a variety of locations to prevent the passage of forbidden or unwanted items hidden in the undercarriage of vehicles. For example, international and state border crossings, airports, military and security checkpoints, and even many commercial structures are protected by systems designed to inspect vehicle undercarriages.

Perhaps the most common conventional method used to perform under vehicle inspections involves a human inspector manipulating a mirror attached to the end of a stick. The inspector manually positions the mirror underneath a vehicle in such a way that he or she can view portions of the vehicle's underside in the mirror's reflection. This allows the inspector to examine the vehicle's underside without having to kneel down or crawl underneath the vehicle.

The so called “mirror on a stick” approach has a number of fairly obvious shortcomings. Most notably, this approach puts the inspector in physical danger by placing him or her near potentially harmful substances, e.g. explosives, caustic chemicals, biological weapons, etc. Furthermore, scanning the entire underside of a vehicle using a mirror on a stick takes a considerable amount of time, which typically leads to serious congestion in high traffic areas. Moreover, human inspectors often fail to notice important details when they are fatigued or in a rush, thereby limiting the reliability of their inspections.

A number of more sophisticated approaches have been proposed in an attempt to provide safer, more efficient, and more reliable ways of inspecting vehicle undercarriages. These approaches include stationary under vehicle scanners and unmanned robotic vehicles.

Conventional stationary under vehicle scanners are characterized by the use of fixed (e.g., unmoving) cameras that image some portion of a vehicle's undercarriage as the vehicle is drive over the scanner. A typical stationary under vehicle scanner comprises a camera strip that captures a number of images of the vehicle's underside and then sends the images to a human inspector for analysis. An example of a stationary under vehicle scanner is disclosed in U.S. Patent Application Publication No. 2003/0185340.

Unmanned ground vehicles (UGVs), or mobile robotic vehicles are also used to image the underside of a vehicle by moving around underneath the vehicle. Typically, an UGV comprises a semi-autonomous unit having a camera and a transmitter. The UGV takes pictures of the vehicle's underside as it moves around and sends the images to a human inspector for analysis.

Stationary under vehicle scanners and UGVs each have some major problems. Stationary under vehicle scanners generally produce very poor quality (e.g., blurry) images due to the fact that the vehicles driven over these devices often travel at inconsistent speeds and impart significant mechanical vibration to the imaging device as they pass over the scanning point. Furthermore, cameras fixed in stationary under vehicle scanners are generally incapable of selectively focusing in on suspicious areas of the undercarriage or adjusting their imaging view around a difficult angle. As such, stationary under vehicle scanners are unable to inspect areas such as wheel wells, which are a common place for stowing illegal items.

UGVs, on the other hand, experience poor and inconsistent image quality due to frequent image transmission failures caused by the mobile unit losing line of sight with a receiver station or due to radio frequency interference. In addition, because UGVs have a fixed size, they cannot adapt to the varying heights of vehicle undercarriages, and therefore cannot accommodate the international ground clearance standard of one (1) inch. Another problem with UGVs is that they have trouble moving around on poor or uneven surfaces such as mud or gravel. Furthermore, inspections made by UGVs are usually random, as the mobile robot moves around selected areas of the vehicle undercarriage rather than uniformly scanning the entire structure. Finally, as with stationary under vehicle scanners, UGVs are unable to inspect most wheel wells because their available view angles are often obstructed by vehicle wheels and other vehicle parts.

In addition, some problems that are common to both stationary under vehicle scanners and UGVs include a tendency to be adversely affected by environmental conditions such as debris and changing weather, and an inability maintain a precise spatial relationship with a vehicle's undercarriage. The first problem may occur, for example, where substances such as dirt or mud come in contact with these devices' optical, mechanical, or electrical components, or where the air temperature causes temperature sensitive components such as digital image sensors to perform sub-optimally. The second problem tends to occur in stationary under vehicle scanners due to their inability to precisely track a vehicle's position, e.g., due to the vehicle's inconsistent speed, elevation, etc., and it occurs in UGVs due to their inability to precisely track their own position, e.g., because they may be moving around on uneven or unpredictable surfaces. The tendency to be adversely affected by environmental conditions increases the maintenance cost and decreases the reliability of these technologies, and the inability to maintain a precise spatial relationship with the vehicle's undercarriage tends to complicate the image capture and analysis process.

Due to these and other manifest limitations in the proposed approaches, the “mirror on a stick” method remained until recently the most reliable form of under vehicle inspection. Given the great risk that this method presents to inspection personnel, however, the mirror on a stick approach is unacceptable.

What is needed, therefore, is a system which is at least as reliable as the mirror on a stick approach, yet which provides a safe and efficient way of inspecting the undercarriages of vehicles.

### SUMMARY OF THE INVENTION

Embodiments of the invention provide an under vehicle inspection system capable of reliably and efficiently detecting suspicious articles in the undercarriages of vehicles while minimizing the risk of physical harm to inspection personnel. In one embodiment, the present invention allows suspicious areas in the undercarriages of vehicles to be selectively and more thoroughly inspected, and it allows obstructed areas of the vehicle undercarriage such as wheel wells to be effectively inspected.

According to one exemplary embodiment of the invention, an under vehicle inspection system comprises a vehicle undercarriage inspection platform and a sensor associated with a sensor carriage mounted on a sensor carriage track associated with the vehicle undercarriage inspection platform. The sensor is adapted to obtain data regarding all or a portion of a stationary vehicle undercarriage as the sensor carriage moves relative to the vehicle undercarriage inspection platform. The system further comprises a data analysis element adapted to receive and evaluating data obtained by the sensor.

According to another exemplary embodiment of the invention, a method of inspecting a vehicle undercarriage is provided. The method comprises scanning the undercarriage of a stationary vehicle using a sensor associated with a sensor carriage mounted on a sensor carriage track, and evaluating data captured by the plurality of sensors.

### BRIEF DESCRIPTION OF THE DRAWINGS

Embodiments of the invention are described in relation to the accompanying drawings. Throughout the drawings like reference numbers indicate like exemplary elements, components, or steps. In the drawings:

FIG. 1 is a conceptual diagram of an under vehicle inspection system in accordance with an exemplary embodiment of the present invention;

FIGS. 2A and 2B each show a conceptual diagram of a sensor carriage and sensor carriage track adapted to transport sensors along the length of a vehicle during an under vehicle inspection in accordance with an exemplary embodiment of the present invention;

FIG. 3 is a conceptual diagram of an under vehicle inspection system in accordance with another exemplary embodiment of the present invention;

FIGS. 4A through 4D are different views of a vehicle undercarriage inspection platform in accordance with an exemplary embodiment of the present invention;

FIG. 5 is a conceptual diagram of a vehicle undercarriage inspection platform for a large vehicle inspection system in accordance with an exemplary embodiment of the present invention; and,

FIG. 6 is a flow chart describing a method of inspecting the undercarriage of a vehicle in accordance with an exemplary embodiment.

### DESCRIPTION OF THE EXEMPLARY EMBODIMENTS

Exemplary embodiments of the invention are described below with reference to the corresponding drawings. These embodiments are presented as teaching examples. The actual scope of the invention is defined by the claims that follow.

One embodiment of the present invention provides an under vehicle inspection system comprising a vehicle undercarriage inspection platform and a plurality of sensors mounted on the vehicle undercarriage inspection platform. The plurality of sensors is adapted to scan all or part of the vehicle undercarriage by moving relative to the vehicle undercarriage inspection platform. Data captured by the plurality of sensors is communicated to an analysis element and evaluated.

The term “platform” is used throughout this description to denote any physical structure capable of receiving and/or supporting a vehicle, in whole or in part, in such a manner that a plurality of sensors associated with the platform may view a significant portion of the vehicle's undercarriage. That is, one group of embodiments specifically contemplates supporting a stationary vehicle driven up onto the platform. Whereas, another group of embodiments contemplates “receiving” a vehicle positioned, at least in part, over it (e.g., straddling it).

For example, the vehicle undercarriage inspection platform may take the form of movable or transportable mechanical structure, such as a tow-able trailer or one or more platform sections or pieces (e.g., a collection of welded beam structures). In one specific embodiment, the one or more platform section may be sized for convenient transport by truck and/or aircraft. The vehicle undercarriage inspection platform may take the form of an “in-ground” or “on-ground” structure constructed, for example, from concrete or welded steel.

Various embodiments of the invention provide platforms of varying height, length, and width. Longer platforms may be formed from connected or related sections that may be added or removed according to the nature of a vehicle inspection being performed.

In certain embodiments of the invention, the plurality of sensors need not be integrated with, physically connected to, and/or mechanically attached to the platform. However, other embodiments of the invention recognize certain benefits in an arrangement where the plurality of sensors is mechanically associated with the platform, but not necessarily integrated with the platform in manner that would preclude ready replacement of the sensors without material movement or deconstruction of the platform.

The term “sensor” is used throughout this description in its broadest sense. Thus, any device that receives stimuli (e.g. heat, pressure, light, motion, electromagnetic fields, or a chemical response, etc.) from its surrounding environment and responds to the stimuli in a distinctive way is considered a sensor for purposes of this description. The term “sensor” includes both passive sensors, i.e. those that do not interact with their environment, as well as active sensors, i.e. those that do. One simple example of an active sensor is a camera with associated lights that shine on a vehicle undercarriage in order to enhance the camera's imaging capabilities. Other ready examples of sensors adapted for use within the context of the invention include various types of optical (both visible light and infrared) cameras, radiation sensors, thermal sensors, chemical detectors, and motion detectors, etc. The “plurality of sensors” in used in this description to refer to more common embodiments of the invention wherein multiple sensors (e.g., one or more cameras, etc.) are used to good effect. Use of this term, however, should not be construed as mandating the use of more than one sensor within embodiment of the invention. Rather, it merely refers to a class of useful embodiments.

In some embodiments of the invention, the sensors are mounted in a “sensor carriage” adapted to hold the sensors and/or related components. The related components may include, for example, power supplies, lights, motors, processing elements such as digital image filters, data transmission/reception hardware, and so on. The sensor carriage may serve a variety of purposes, such as providing a convenient mechanism for moving the sensors and/or related components along an under vehicle inspection platform, or protecting the sensors and/or other components from harmful environmental conditions such as debris and adverse weather conditions.

In some embodiments, the sensor carriage comprises one or more structures, each adapted to receive and hold sensors and/or related components. In one embodiment, the structure comprises a floor and one or more walls that collectively form a protective enclosure adapted to keep out debris, moisture, and so on. Alternatively, a transparent or partially transparent dome like structure may be mounted on a floor to protect the sensors and/or related components.

In some embodiments, the sensor platform will be moved along the length of the platform by an externally applied force or mechanism. For example, the sensor platform may be push/pulled along the length of the platform by a belt, cable, chain, etc., connected to an external drive mechanism such as a motor. Alternatively, the sensor carriage may be moved along the length of the platform by an integrated drive mechanism. For example, the sensor carriage may be provided with a set of gears, linkages, wheels, or similar mechanical/electrical components adapted to move the sensor carriage along the length of the platform. In either alternative the carriage sensor may be mechanically associated with a track integral to the platform or a track otherwise provided but associated with the platform.

Where the sensors comprise one or more optical cameras, the cameras may comprise either still cameras or video cameras, and may be digital and/or film based in their imaging capabilities. Where digital cameras are used, they may include charge coupled device (CCD) or complementary metal oxide semiconductor (CMOS) based image sensors.

According to one embodiment of the invention, at least one of the plurality of sensors is a digital line scan camera. The digital line scan camera typically uses a linear array of CCDs to build up a series of single pixel lines, thereby creating a final image. This allows the camera to create an image covering a large area of a vehicle's undercarriage without having to rely on techniques such as stitching together multiple images. In addition, the digital line scan camera provides exceptional resolution and “zoom” capability, thereby allowing the under vehicle inspection system to consider the fine details of a vehicle's undercarriage. In this context, the term “zooming” may refer to an enhancement process performed on digital image data provided by the digital line scan camera (or similar device) by an associated data analysis system either integrally provided within the sensor carriage or externally provided, for example, as part of an attached data analysis element.

The plurality of sensors associated with a sensor carriage will be capable of movement in at least one direction relative to a vehicle undercarriage inspection platform. This direction as referenced above is arbitrarily referred to as the “length” of the platform as it corresponds to the length of the vehicle being imaged or scanned. However, one or more of the sensors, in associated with or independent from the sensor carriage, may also be moved vertically, horizontally, angularly, rotationally, or any combination thereof. Further, individual sensors within a plurality of sensors may be independently moved and/or moved as one or more coordinated pluralities. Furthermore, individual or grouped sensors may perform their respective functions at varying ranges of resolution and/or sensitivity. For example, a camera may zoom in and zoom out on a particular region of an undercarriage, while a chemical detector may simultaneously sample over a broader area, and so forth.

The term “data analysis element” refers to any system capable of receiving, communicating, storing, and/or evaluating data derived from the plurality of sensors. Data, such as visual image data, is often communicated directly to a human operator via (e.g.,) a monitor. Evaluation of data typically comprises classifying the data as “suspicious” or “not suspicious.” In one embodiment, a human operator may interact with a data analysis element of the system to classify sensor data according to objective and/or subjective criteria. In another embodiment, the data analysis element will comprise a digital logic system receiving digital data from the plurality of sensors and classifying the data using machine learning techniques, or a simple threshold based system, whereby a predetermined response (e.g. an alarm) is triggered anytime a certain parameter exceeds an allowable threshold.

The data analysis element typically receives data captured by at least one of the sensors through some form of intermediate link connecting the data analysis element with the plurality of sensors. This link may be formed using a hardwire connection or a wireless connection. Many embodiments of the invention will preferably use a hardwire connection, as wireless transmission will be deemed undesirable. Where the link is a hardwire connection, the hardwire connection may use any one of a variety of protocols, components, and transmission media, including Ethernet, copper wire, fiber optic, and so forth. Where the link is a wireless connection, the wireless connection may use any one of a variety of protocols and components, including Bluetooth, 802.11, lasers, radio frequency communication, etc.

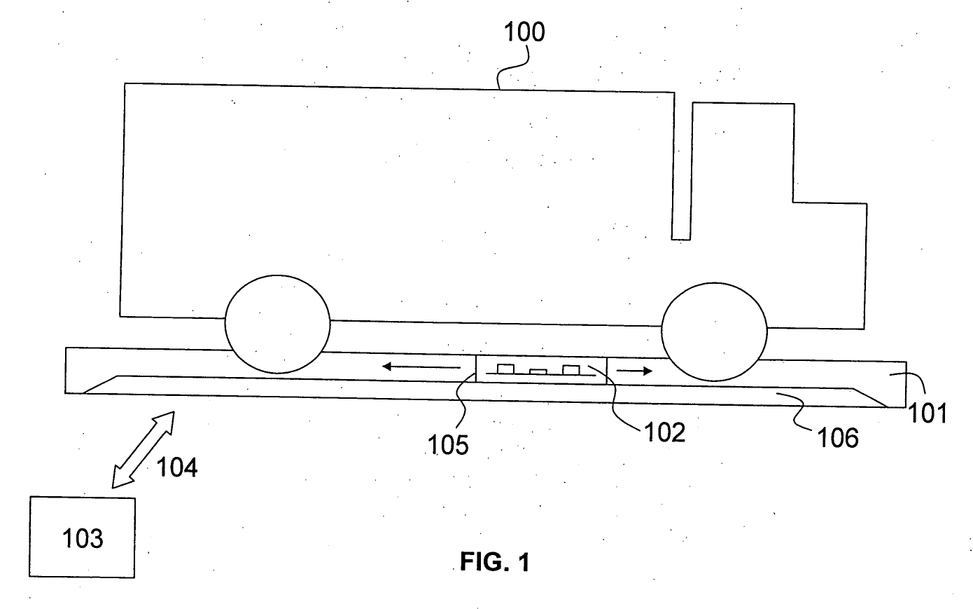

FIG. 1 is a conceptual diagram of an under vehicle inspection system in accordance with one embodiment of the invention. Referring to FIG. 1, an under vehicle inspection system comprises a vehicle undercarriage inspection platform 101, one or more sensors 102 associated with vehicle undercarriage inspection platform 101, and a data analysis element 103 receiving data adapted to receive, capture, and/or evaluate data obtained by sensors 102. In the illustrated embodiment, sensors 102 obtain data my moving with respect to the undercarriage of a stationary vehicle 100 parked on or parked over the vehicle undercarriage inspection platform 101. A communications link 104 transmits data obtained by sensors 102 to data analysis element 103.

In one possible variation on the under vehicle inspection system shown in FIG. 1, sensors 102 are mounted within a sensor carriage 105 which is mechanically associated with on a sensor carriage track 106. Sensor carriage track 106 may take many different forms, but will usually be designed to provide precise control over the movement and/or positioning of sensor carriage 105 in order to optimize use of sensors 102 in the collection of data.

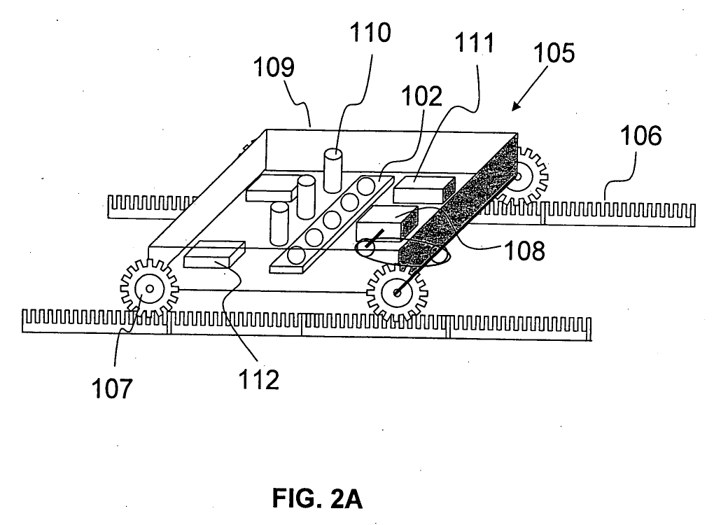

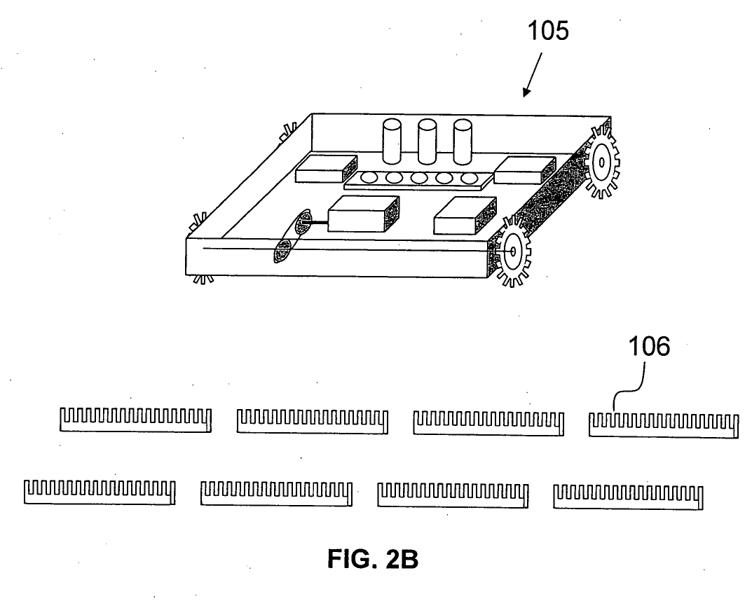

FIG. 2A further illustrates one possible embodiment of sensor carriage 105 and sensor carriage track 106. As shown in FIG. 2A, sensor carriage 105 comprises a chassis 109 adapted to hold sensors 102, and a set of wheel gears 107 connected by a pair of axels associated with chassis 109. The axel and wheel gear combinations are merely exemplary of a broad range of “transport mechanisms” potentially adapted for use within embodiments of the invention. For example, axel mounted wheels made form rubber, steel, or a composite material may be used in conjunction with a slotted wheel track. Any mechanical, electrical, magnetic, electro-mechanical, electro-magnetic, or hydraulic mechanism adapted to move and/or position sensor carriage 105 in relation to a sensor carriage track may serve as a sensor carriage transport mechanism.

In this context, it should also be noted that the sensor carriage track may be provide as an integral part of the undercarriage inspection platform, or as an associated system element. Thus, the slotted gear track illustrated in FIG. 2A is one example of a sensor carriage track 106 mechanically integrated into the structure of a platform. In the illustrated example, sensor carriage 105 rides on top of sensor carriage track 106, but it might alternately be provided as hanging from a portion of the platform, or mechanically captured within an upper and lower bracketed track, for example. As illustrated, however, wheel gears 107 on sensor carriage 105 mate with a sensor carriage track 106 comprising a parallel pair of slotted tracks. In this manner, sensor carriage 105 may be precisely moved and/or positioned along sensor carriage track 106 using a rack and pinion type system.

Referring again to FIG. 2A, chassis 109 also comprises a stepper motor 108, a processing element 111, one or more lights 110, and a power supply 112. Stepper motor 108 is one example of a range of sensor carriage “drive mechanisms” adapted to apply mechanical work to one or more transport mechanisms associated with sensor carriage 105. Other motor types (e.g., DC, AC, inductive, magnetic, etc.) may be used.

However, in the illustrated embodiment, stepper motor 108 is mounted within chassis 109 to control the motion of sensor carriage 105 along sensor carriage track 106 by turning one or both of the axels connecting wheel gears 107. In some embodiments a stepper motor, or similar drive mechanism having very precise control characteristics, will be preferred, whereby the motion and/or position of sensor carriage 105 is controllable down to several millimeters.

Processing element 111 is adapted to receive and process data from sensors 102. In addition, processing element 111 may be further adapted to transmit data to and receive data from data analysis element 103. For example, data received from data analysis element 103 may be used to control the actuation of and movement of sensors 102 as well as the movement of sensor carriage 105. Indeed, processing element 111 may send and receive many and various types of data, such as control data, filtered or raw sensor (e.g., image) data obtained by sensors 102, etc. In some embodiments, processing element 111 provides various signal processing functions for preprocessing or evaluating the sensor data. For example, processing element 111 may implement image processing routines such as feature extraction, edge detection, compression/decompression, etc. At least one reasons for implementing signal processing functions on processing element 111 is to decrease the amount data that has to be transferred to data analysis element 103.

Lights 110 are generally used whenever sensors 102 include a camera so that areas of a vehicle undercarriage that are being inspected are adequately illuminated. Lights 110 may be fixed in their position and field of illumination, or may be variably positioned (e.g., angled or moved) to provide better illumination.

Power supply 112 may be one or more DC power sources, such as a battery, adapted to provide power to lights 110, sensors 102, stepper motor 108, and/or processing element 111.

FIG. 2B shows another view of sensor carriage 105 and more particularly illustrates one embodiment of sensor carriage track 106, wherein sensor carriage 105 is designed to be readily mounted and detached from carriage track 106 and sensor carriage track 106 comprises a plurality of connectable track lengths.

In certain embodiments of the invention, an under vehicle inspection system may be adapted to inspect very long vehicle, such as trucks. In such embodiments, it may be beneficial to provide sensor carriage track 106 in a plurality of pieces to facilitate storage and transportation. For example, military aircraft and commercial hauling device routinely require that equipment to be transported comply with defined size and weigh restrictions.

In addition, designing sensor carriage 105 to be easily mounted/detached from sensor carriage track 106 makes it easier to transport, inspect, replace and maintain sensor carriage 105. Moreover, because of its detachability, sensor carriage 105 could readily be interchanged with a different sensor carriage, e.g., one with a different type of sensors, or more than one sensor carriage could be placed on an extended carriage track to expedite the scanning process. For example, two sensor carriages 105 could be placed on respective opposite ends of sensor carriage track 106 so that one part of a vehicle can be scanned by one of the two sensor carriages and another part of the vehicle can be scanned by the other of the two sensor carriages. Alternatively, multiple sensor carriages having different sensor types may follow one another along a sensor carriage track in a single scan of a vehicle.

Although not shown in FIGS. 2A and 2B, a covering may be provided over the top of sensor carriage 105 to provide additional protection against environmental conditions such as debris and moisture. The cover may be transparent in whole or in part. The environment within enclosed portions of sensor carriage 105 may be regulated, for example, by cooling fans, heat sinks, and so forth.

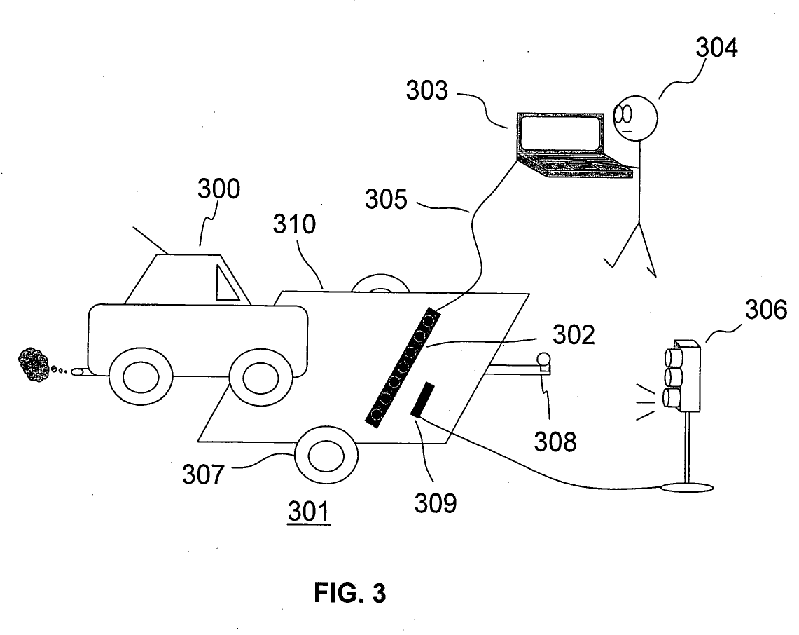

FIG. 3 is a conceptual drawing of an under vehicle inspection system in accordance with a more specific embodiment of the invention. Referring to FIG. 3, the illustrated under vehicle inspection system takes the form of a moveable (e.g., towable) trailer 301, having a plurality of cameras 302 mounted thereon, and communicating with a computer 303 (e.g., a laptop or table Personal Computer (PC) or Personal Digital Assistant (PDA) via a hardwire connection 305. Computer 303 is adapted to receive image data captured by the plurality of cameras 302 and display the data on a monitor or screen. A human operator 304 is able to evaluate the visual images thus provided.

The plurality of cameras 302 captures image data associated with the undercarriage of a stationary vehicle 300 parked, wholly or in part, on trailer 301 by moving along the length of trailer 301 at a defined speed and scanning as it goes. In one embodiment, trailer 301 comprises a metal frame assembly 310 mounted on wheels 307 and attached to a trailer hitch 308 in a manner consistent with conventional trailers capable of being towed behind a vehicle.

The under vehicle inspection system optionally comprises an associated signaling system 306 that controls passage of vehicle 300 over trailer 301 and signals the vehicle's operator when the vehicle is properly positioned for scanning. Signaling system 306 typically turns on a red light/green light combination, but may take any number of other forms. Signaling system 306 may be associated with one or more detection devices adapted to indicate whether a vehicle is properly positioned on trailer 301. A pressure sensor 309 appropriately located on trailer 301 in one example of such a detection device. Alternatively, human operator 304 may visually determine whether vehicle 300 is properly positioned on trailer 301 for inspection.

Power is generally provided to the under vehicle inspection system by electrical mains and/or a portable gasoline/diesel generator. Alternative sources of power for the under vehicle inspection system include, for example, solar power, batteries, etc.

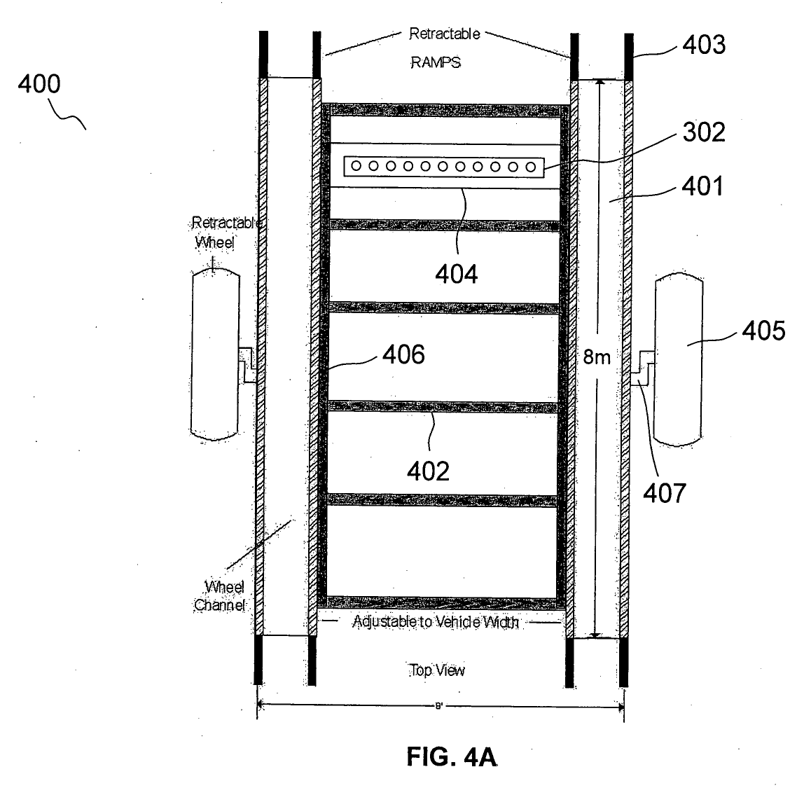

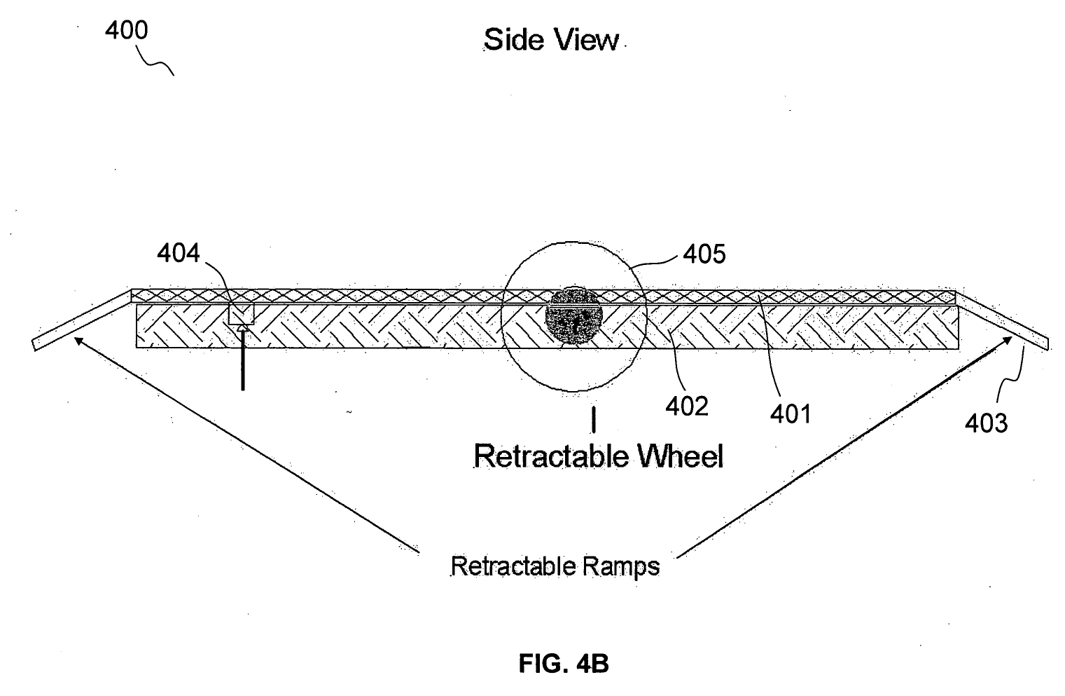

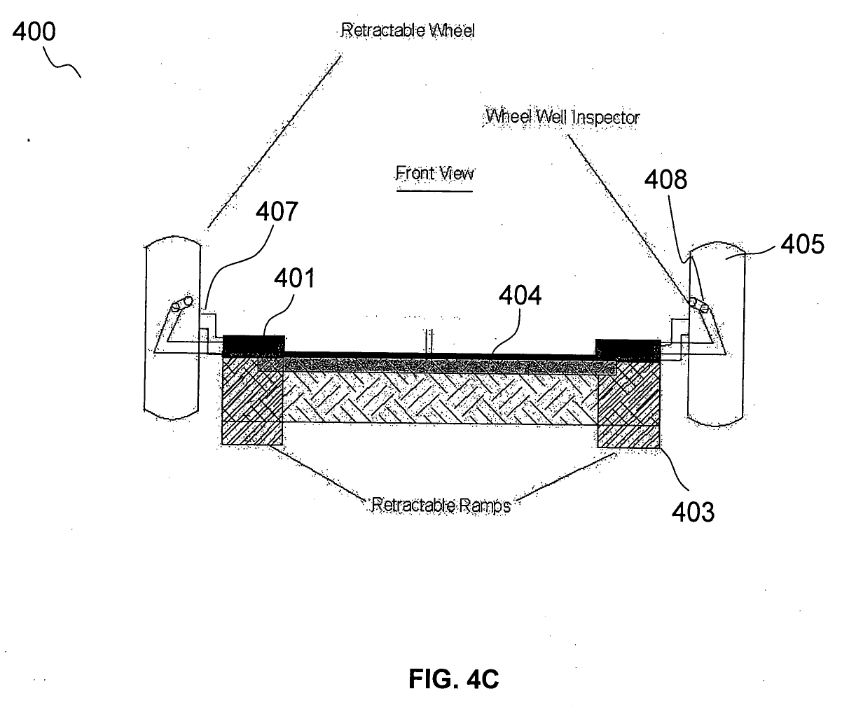

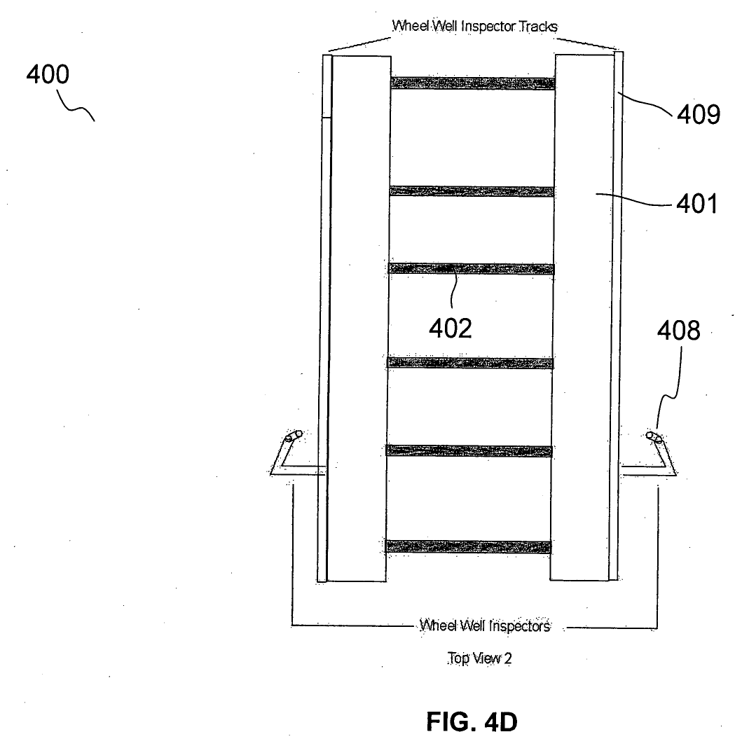

FIGS. 4A through 4D are different views of a trailer 400 adapted for use within the embodiment of the invention shown in FIG. 3.

FIG. 4A is a first top view of trailer 400. Referring to FIG. 4A, trailer 300 comprises wheel channels 401 connected to a frame 402, retractable ramps 403 attached to both ends of wheel channels 401, retractable wheels 405 attached to frame 402, and a camera bar 404 having a plurality of cameras mounted thereon. One or more cameras 302 are contained (along with other related system components as described above) in sensor carriage 404 which is adapted to move along the length of trailer 400. Sensor carriage 404 may be mounted on a sensor carriage track (not shown) associated with frame 402. The length of wheel channels 401 will vary by application, but in one embodiment will be about 8 m.

Sensor carriage 404 captures image data using cameras 302 s as is moves along the length of trailer 400. The speed and movement of sensor carriage 404 may be varied according to the nature of the vehicle being scanned or in relation to a particular region of the vehicle. One or more of cameras 302 contained within sensor carriage 404 may be provided with a zoom capability so that suspicious regions or components of the vehicle undercarriage may be examined more thoroughly. Furthermore, in certain embodiments and where applicable to some applications, sensor carriage 404 may be adapted to make multiple passes over a selected area of the vehicle undercarriage. In other applications and embodiments, sensor carriage 404 may be adapted to make temporary stops during a scanning operation in order to more particularly examine a suspicious area.

Trailer 400 is capable of making a number of size adjustments to provide flexibility, convenience, and ease of use. These adjustments may be made either manually or using mechanical means, such as motors, electrical drive systems, or hydraulic drive systems, for example. For example, the width of wheel channels 401 may be made adjustable to accommodate vehicles of varying chassis widths and/or different wheel types, sizes or configurations. Similarly, the separation distance between wheel channels 401 may be made adjustable to accommodate vehicles having different chassis widths. Also, the length of wheel channels 401 may be adjusted to accommodate longer or shorter vehicles.

Retractable wheels 405 allow trailer 400 to be readily transported and deployed. Retractable wheels 405 allow trailer 400 to be lifted for towing or other movement and lowered to the ground for deployment. According to the exemplary embodiment shown in FIG. 4A, retractable wheels 405 raise and lower trailer 400 using rotating angled axels 407 attached between frame 402 and retractable wheels 405. Where rotating angled axels 407 are rotated upwards, trailer 400 lowers until it rests flat on the ground. Where rotating angled axels 407 are rotated downwards, trailer 400 rises so that it can be moved. Rotating angled axels 407 are typically rotated using hydraulics or an electric motor. Alternatively, the trailer can be raised or lowered using air-shocks.

FIG. 4B is a side view of exemplary trailer 400. FIG. 4B shows retractable ramps 403 in their extended positions. The extended positioning of retractable ramps 403 allows vehicles to drive onto and off of trailer 400. Retractable ramps 403 are placed in a retracted position within frame 402 while trailer 400 is being moved, and may be positioned in an upright position to control the passage of vehicles on and off of trailer 400. For example, the upright positioning of one set of retractable ramps 403 may be used to prevent vehicles from exiting or passing over trailer 400 before a complete inspection has been conducted. A number of alternative means are available for controlling the passage of vehicles on and off trailer 400, including various barriers, such as barrier arms or gates, tire-rippers or spikes, etc.

FIG. 4C is a front view of exemplary trailer 400. Here, trailer 400 is shown in a deployed position wherein rotating angled axels 407 are rotated upwards and retractable ramps 403 are extended. Wheel well inspectors 408 are optionally attached to frame 402 to enable the under vehicle inspection system to more thoroughly inspect vehicle wheel wells. In one embodiment, wheel well inspectors 408 generally comprise cameras mounted on robotic arms attached to frame 402. Camera(s) within this arrangement may be adjusted in several ways, for example, by rotating, tilt, pan, zoom, etc. Wheel well inspectors 408 may be designed to traverse along wheel well inspection tracks 409 (shown in FIG. 4D) using an electric, mechanical or manual drive means.

FIG. 4D is a second top view of exemplary trailer 400. Referring to FIG. 4D, wheel well inspector tracks 409 may span the entire length of trailer 400, giving wheel well inspectors 408 the ability to completely scan side areas of vehicles from front to back, or a wheel well regardless of its particular location on the vehicle. In an alternate embodiment, wheel well inspection sensors (e.g., one or more cameras) may be mounted at stationary positions proximate the vehicle undercarriage inspection platform. For example, one or more cameras may be mounted (fixed or moveable) onto posts positioned near the entrance to the inspection platform. In such embodiments, wheel wells may be visually inspected and/or imaged as a vehicle come into position upon the inspection platform.

Various adjustments to trailer 400 and scanning procedures described with respect to FIGS. 4A through 4D may be controlled either by a human operator through a computer or some other synthetic interface, or by an automatic control procedure. Examples of automatic control procedures include use of range finders or machine vision techniques to determine the dimensions of a vehicle, and determination of vehicle dimensions by comparing images of a vehicle against a database of vehicle template images and adjusting trailer 400 and/or the plurality of cameras accordingly.

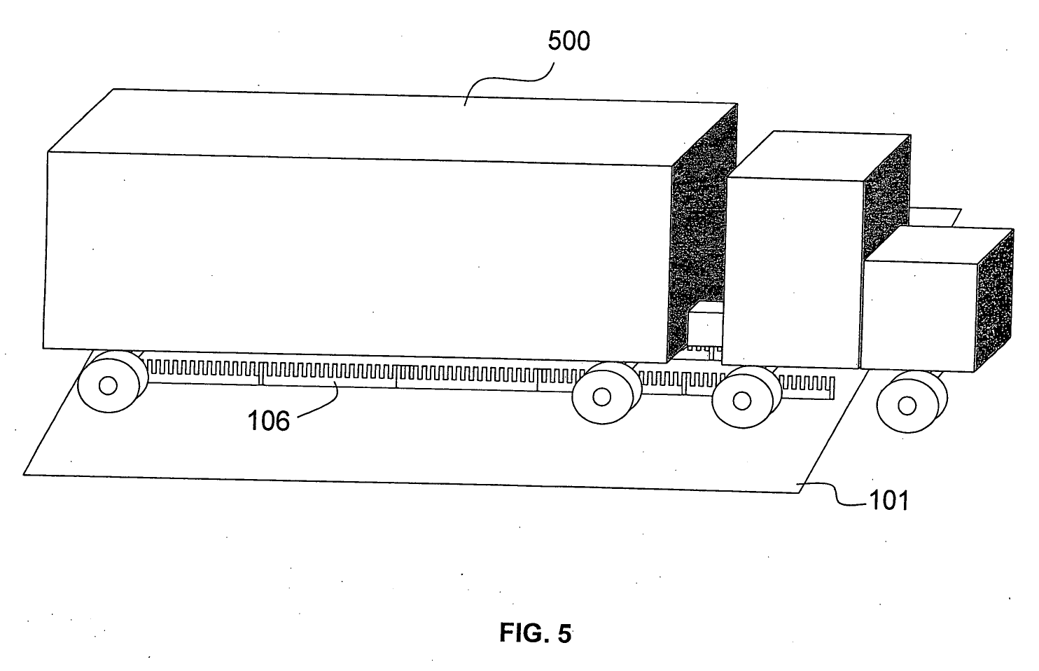

FIG. 5 is a conceptual diagram of a vehicle undercarriage inspection platform for a large vehicle inspection system in accordance with another embodiment of the invention. In FIG. 5, sensor carriage track 106 is assembled as part of an vehicle undercarriage inspection platform 101 adapted to inspect a variety of vehicles, including very large vehicles 500 such as trucks. Such vehicles may be drive onto or over top of vehicle undercarriage platform 101, such that the vehicle essentially straddles the movement path of sensor carriage track 106. Although sensor carriage track 106 is shown in an on-ground configuration in FIG. 5, sensor carriage track 106 can also be located below ground level or on an elevated surface such as a permanent platform pad or a moveable trailer.

In FIG. 5, sensor carriage track 106 may be assembled by connecting in series multiple track section, e.g., as illustrated in FIG. 2B. Once sensor carriage track 106 is assembled, sensor carriage 105 (not shown) is placed on sensor carriage track 106 to perform inspections. Since large vehicle 500 straddles sensor carriage track 106, sensor carriage 105 may be provisioned with sensors 102 adapted to tilt outward (or tilt focus at variable angles) in order to inspect parts of the undercarriage of vehicle 500 that are not directly above any part of carriage sensor track 106. Alternatively, or additionally, sensor carriage may also include robotic arms similar to those used for wheel well inspectors 408 to extend its sensing field (e.g., field of view) beyond carriage sensor track.

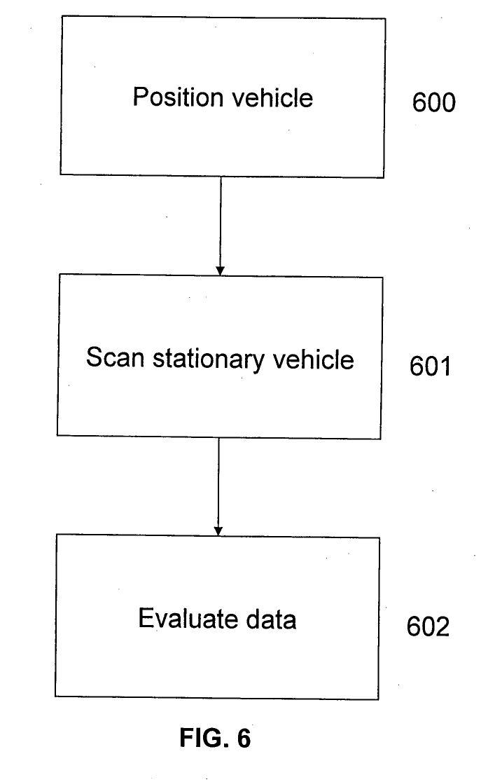

FIG. 6 is a flow chart describing an exemplary method of inspecting the undercarriage of a vehicle in accordance with one embodiment of the invention.

Referring to FIG. 6, the method comprises positioning a vehicle in relation to a vehicle undercarriage inspection platform (600). Vehicle positioning may entail driving a vehicle onto or over a platform. Positioning the vehicle relative to the vehicle undercarriage inspection platform may be accomplished using a signaling system such as red light/green light combination, and/or a movable barrier.

Once properly positioned, the vehicle is held stationary relative to the vehicle undercarriage inspection platform while sensors scan the undercarriage of the vehicle (601). Maintaining the vehicle in a stationary position relative to the vehicle undercarriage inspection platform may be accomplished using barriers to prevent the vehicle from exiting or passing over the vehicle undercarriage inspection platform.

Thereafter, data obtain from the scan may be evaluated using a data analysis element (602). Evaluating the data captured by the plurality of sensors may be accomplished by receiving the data in a computer, displaying the data to a human operator, and allowing the human operator to use subjective or objective criteria to classify the data as suspicious or not suspicious. A determination by the human operator that some of the displayed data is suspicious may result in further examination of the implicated vehicle area, or an alarm actuation warning the general area of the vehicle.

Multiple embodiments of the invention are characterized by the use of an under vehicle inspection system adapted for use in the inspection of a stationary vehicle. As described above, practical implementations of the invention may take the form of a moveable trailer, an in-ground or above ground installation (e.g., a concrete or steel structure), or an on-ground structure moved into or assembled in place. Unlike UGVs the plurality of sensors and its scanning path may be fixed in relation to the under vehicle inspection system. Accordingly, a clear and more uniform undercarriage scan may be obtained.

Those of ordinary skill in the art will recognize that the foregoing embodiments are subject to numerous modifications and adaptations. In this regard, the teaching embodiments are given by way of example and do not exhaust the scope of the invention which is defined by the attached claims.

What is claimed is:

1. An under vehicle inspection system, comprising:
a vehicle undercarriage inspection platform;
a sensor carriage track associated with the vehicle undercarriage inspection platform;
a sensor carriage mounted on the sensor carriage track and adapted to move along the sensor carriage track;
a sensor associated with the sensor carriage and adapted to scan the undercarriage of a stationary vehicle positioned relative the vehicle undercarriage inspection platform as the sensor carriage moves along the sensor carriage track; and,
a data analysis element adapted to receive and evaluate data obtained by the sensor.

2. The under vehicle inspection system of claim 1, wherein the sensor carriage comprises:
a chassis adapted to hold the sensor; and,
a transport mechanism adapted to move the sensor carriage along the sensor track.

3. The under vehicle inspection system of claim 1, wherein the transport mechanism comprises a plurality of wheel gears connected by respective axels associated with the chassis.

4. The under vehicle inspection system of claim 2, wherein the sensor carriage further comprises a drive mechanism associated with the transport mechanism.

5. The under vehicle inspection system of claim 4, wherein the drive mechanism comprises a stepper motor mounted on the chassis and operatively connected to the transport mechanism.

6. The under vehicle inspection system of claim 1, wherein the sensor carriage further comprises:
a light associated with the sensor and adapted to illuminate the undercarriage of the stationary vehicle.

7. The under vehicle inspection system of claim 6, wherein the light provides either a fixed field of illumination or a directionally variable field of illumination.

8. The under vehicle inspection system of claim 1, wherein the sensor carriage further comprises a processing element associated with the sensor and adapted to communicate data with the data analysis element.

9. The under vehicle inspection system of claim 1, wherein the sensor carriage track comprises a plurality of track sections adapted to be connected in series to define a length for the sensor carriage track.

10. The under vehicle inspection system of claim 1, wherein the sensor comprises; an optical camera, a chemical sensor, a thermal detector, or a radiation detector.

11. The under vehicle inspection system of claim 10, wherein the sensor comprises a digital line scan camera having zoom capability.

12. The under vehicle inspection system of claim 1, wherein data obtained by the sensor is received by the data analysis element through a hardwire link.

13. The under vehicle inspection system of claim 1, wherein the data obtained by the sensor is received by the data analysis element through a wireless link.

14. The under vehicle inspection system of claim 1, further comprising:
a signaling system adapted to position the vehicle relative to the undercarriage inspection platform.

15. The under vehicle inspection system of claim 1, wherein the sensor comprises a digital line scan camera with zoom capability; and,
wherein the data analysis element comprises a Personal Computer (PC) or Personal Digital Assistant (PDA) adapted to receive image data obtained by the digital line scan camera and display the image data.

16. The under vehicle inspection system of claim 1, wherein the vehicle undercarriage inspection platform comprises a trailer.

17. The under vehicle inspection system of claim 16, wherein the trailer comprises:
a frame;
wheel channels attached to the frame;
retractable ramps attached to the wheel channels; and,
retractable wheels attached to the frame.

18. The under vehicle inspection system of claim 1, wherein the vehicle inspection system comprises an in-ground structure.

19. The under vehicle inspection system of claim 1, wherein the vehicle inspection system comprises an on-ground structure.

20. The under vehicle inspection system of claim 19, wherein the on-ground structure is transportable in a plurality of pieces.

21. A method of inspecting the undercarriage of a stationary vehicle, the method comprising:
scanning the undercarriage of the stationary vehicle positioned in relation to a vehicle undercarriage inspection platform by moving a sensor carriage comprising a sensor along a sensor carriage track associated with the vehicle undercarriage inspection platform; and,
evaluating data obtained by the sensor using a data analysis element.

22. The method of claim 21, wherein the sensor comprises an optical camera, a chemical sensor, a thermal detector, or a radiation detector.

23. The method of claim 21, wherein moving the sensor carriage along the sensor carriage track comprises operating a stepper motor to turn an axel associated with the sensor carriage.

24. The method of claim 21, wherein the sensor comprises a digital line scan camera having zoom capability, and wherein the method further comprises:
stopping the movement of the sensor carriage relative to the vehicle undercarriage inspection platform during a scan of the vehicle undercarriage; and,
zooming the digital line scan camera onto a selected portion of the vehicle undercarriage.

25. The method of claim 21, wherein the vehicle undercarriage inspection platform comprises a trailer, and wherein the method further comprises:
towing the trailer to a location; and,
deploying the trailer at the location before positioning the vehicle on the trailer.

26. The method of claim 21, wherein the vehicle undercarriage inspection platform comprises an in-ground structure, and wherein the method further comprises:
positioning the vehicle over the in-ground structure before scanning the undercarriage of the stationary vehicle.

27. The method of claim 21, wherein the vehicle undercarriage inspection platform comprises an on-ground structure, and wherein the method further comprises:
positioning the vehicle over the on-ground structure before scanning the undercarriage of the stationary vehicle.

28. The method of claim 27, wherein the method further comprises; deploying the on-ground structure at a location by assembling a plurality of pieces.

29. The method of claim 27, wherein positioning the vehicle over the vehicle undercarriage inspection platform comprises; visually indicating to a vehicle operator using a green light and a red light.

30. The method of claim 27, wherein positioning the vehicle over the vehicle undercarriage inspection platform comprises; moving a barrier adapted to prevent passage or exit of the vehicle from the vehicle undercarriage inspection platform.
